(19) United States
(12) Patent Application Publication
(10) Pub. No.: US 2004/0101350 A1
(43) Pub. Date: May 27, 2004

(54) Mounting and dismounting device e.g. for a sleeve or bearing with a locking means comprising two conical elements

(76) Inventor: Ragnar Fohlen, Uddevalla (SE)

Correspondence Address: YOUNG & THOMPSON, 745 SOUTH 23RD STREET 2ND FLOOR, ARLINGTON, VA, 22202

(21) Appl. No.: 10/363,732

(22) PCT Filed: Aug. 30, 2001
(86) PCT No.: PCT/SE01/01810

(30) Foreign Application Priority Data
Sep. 8, 2000 (SE) 0003200-3

(51) Int. Cl. F16D 1/12

(52) U.S. Cl. 403/52

(57) ABSTRACT

The invention refers to a mounting and dismounting device (10) for an annular machine element (40) being mountable on an axle (20), which device (10) comprises pressing means (12), counteracting means (14) and tightening means (16, 42), where the tightening means (16, 42) is connectable to the counteracting means (14) for transfer of axial force to the machine element (40). The invention is characterized in that the counteracting means (14) comprises two parts and is provided to exert a radial force locking the counteracting means (14) against the axle (20), at exertion of axial force via the tightening means (16, 42).

The present invention refers to a mounting and dismounting device for an annular machine element being mountable on an axle, which device comprises pressing means, counteracting moans and tightening means, where the tightening means is connectable to the counteracting mean for transfer of axial force to the machine element.

### THE BACKGROUND OF THE INVENTION AND THE PROBLEM

The device according to the invention is a tool used during mounting of machine elements such as for example rolling bearings on axles in e.g. gear boxes and electric motors. Similarly, the device according to the invention can be used during dismounting of the same. Further, the device can be used for mounting and dismounting of other machine elements such as for example bushings, sliding bearings and transmission wheels.

Above all, when mounting bearings on axles in electric motors and gear boxes it is very important to try to eliminate arise of uncontrollable axial forces in the axle, as such forces can give rise to longitudinal displacements of the axle which can damage the function or components connected to the actual axle, for example drive gear in gear boxes, which are sensitive to axial displacements. The mounting and dismounting device according to the invention is designed so that only very small axial loads arise in the axle, which do not have a negative effect on the other components arranged on the axle.

The invention is also provided to reduce misalignment loads on the bearing during the mounting procedure. Usually, the bearing is knocked onto the axle by a hammer and a sleeve and this method give rise to misalignment loads both on the be and the axle, which misalignment loads in turn can lead to a shortened endurance time of the bearing and also damages to other components mounted on said axle.

In industry it is desired that a mounting and dismounting device according to the above-described type is also easy and quick to use, so that it is possible to gain time. It is also an advantage if it can be arranged on the axle at an optional position so that it can be used in many other types of applications and that the number of parts in the tool is low.

From for stance the document EP 0 424 584 it is prior known a mounting device for e.g. bearings, which comprises a jig arrangement for mounting and fixing a bearing on an axle. The device firstly used in connection with conical bearings and comprises a conical part, which is threaded in one end, and provided to the axle end with the threads extending outwards. The bearing is pressed onto this part and a housing is surrounding the bearing. To mount and fix the bearing, an outer plate is screwed onto the conical part. The plate keeps the jig arrangement together and with screws, provided in the plate, the bearing can be positioned in the axial direction. The disadvantage with this jig arrangement, except for comprising many parts, is that it can not be removed tom the axle as long as the bearing shall be mounted to the axle and that it implies that the bearing shall be positioned in the vicinity of the axle end.

From DE 412 595 it is prior known a device for mounting of bearings in which the tightening means such as screws are used to press a pressing washer against the bearing. The device comprises a fixed part, counteracting means, and a movable part, pressing washer. In a first embodiment the counteracting means is provided with pins which fit in corresponding recesses in the axle, so that the countering means is prevented from sliding away along the axle when the bearing is to be pushed on. In a second embodiment the counteracting means is in two parts so that it can be arranged in a slot radially provided around the axle. Only the friction between the screws and the pressing washer prevent the counteracting means from falling off the axle. Thus, these types of bearing mounting tools cast only be used in applications with special designed axles with suitable recesses. Further, the distribution of and the number of screws, and the fact that the counteracting means in the last mentioned embodiment is in two parts, lead to a large risk of existing misalignment loads to the bearing during mounting.

Thus, with reference to at least the above mentioned disadvantages, it can be said that these tools for mounting of bearings is not suitable for easy mounting and dismounting of machine elements such as for example rolling bearings on axles in gear boxes and electric motors, and other types of machine elements such as bushings, sliding bearings and transmission wheels.

### THE OBJECT OF THE INVENTION AND THE SOLUTION TO THE PROBLEM

Thus, the object of the invention is to provide a mounting and dismounting device for machine element such as for example bearings, which device:

does not give rise to any misalignment loads on the machine element during mounting/dismounting,

eliminates the arise of uncontrollable axial forces in the axle which can damage other machine elements mounted on the axle,

gives an even pressure on the machine element during mounting/dismounting,

is easy to mount and demount on to axle,

can be arranged at an optional position on the axle,

is prevented form sliding away along the axle during mounting/dismounting of the machine element,

only has to be arranged on the axle during mounting/dismounting procedure,

is easy to manufacture, and

comprises few parts.

These objects have been solved in that the counteracting means comprises two parts and is provided to exert a radial force locking the counteracting against the axle, at exertion of axial force via the tightening means.

### DESCRIPTION OF THE DRAWINGS

In the following, the invention will be more closely described with reference to the attached drawings, in which:

FIG. 1 shows a top view and a section taken along the line A-A of an embodiment of the invention in which a bearing is to be mounted,

FIG. 2 shows a top view and a section taken along the line B-B of the embodiment of FIG. 1 during dismounting of a bearing, and

FIG. 3 shows a top view and a section taken along the line C-C where hydraulics is used during dismounting of a bearing.

### DESCRIPTION OF EMBODIMENTS

In the following, the mounting and dismounting device will be described with help of a number of embodiments and with reference to the attached drawings. The device as a whole is denoted with the numeral 10.

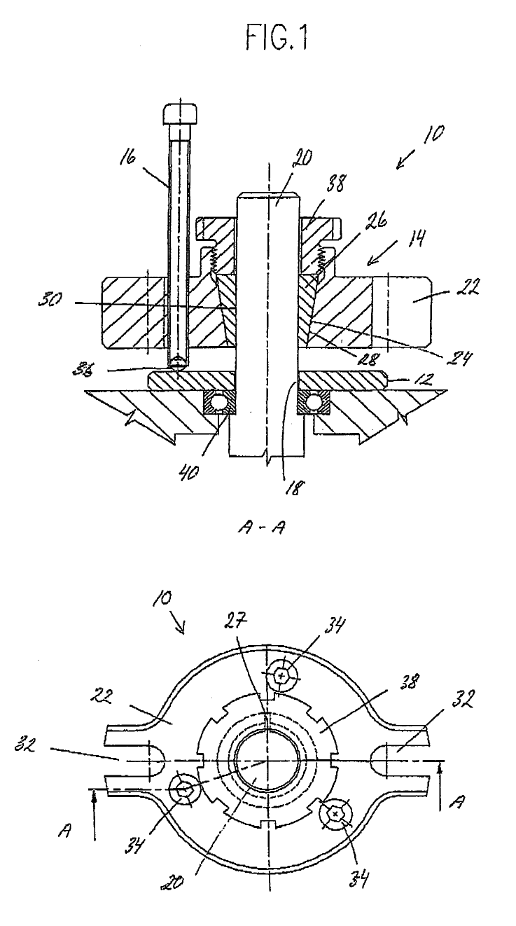

The mounting and dismounting device 10 according to the invention comprises pressing means 12, counteracting means 14 and tightening means 16. In an embodiment of the invention, where a bearing is to be mounted on an axle, which is shown in FIG. 1, the pressing means 12 is forced as a having an axial hole 18 with a diameter which is preferably the same as the one of the axle 20 on which the bearing is to be mounted. The counteracting means 14 comprises partly an outer element 22 with a through hole with a conical inner envelope surface 24 and partly an element 26 in the form of a sleeve with a conical outer envelope surface 28 and a longitudinal slot 27. The conicity of both said surfaces 24, 28 corresponds to each other. Further, the inner element 26 has a through hole 30 with a diameter is corresponding to the diameter of the axle 20. In the outer element 22 there are two recesses 32 in the outer surface and three axial, threaded, through screw holes 34 which are symmetrically distributed around the axle 20. Moreover, the device 10 comprises tightening screws 16 which fit in the three through screw holes 34. Eventually, these three screws 16 can be provided with a steel ball 36 in the end which will reduce the friction between pressing washer 12 and the screw 16. Further, the device 10 comprises biasing means 38 in the form of a bushing that can be fixedly threaded into the outer element 22 of the counteracting means 14 at the edge of the conical hole.

Below, and with reference to FIG. 1, mounting of a bearing 40 on an axle 20 will be described where the device according to the invention is used. Naturally, even other machine elements than bearings can be mounted with the tool according to the present invention.

The bearing 40 is pushed up on the axle 20 on which it is to be mounted. Thereafter, the pressing means 12, the washer, is arranged onto the axle 20 adjacent the bearing 40. Preferably, the washer 12 is chosen so that it has at least as large outer diameter as the outer diameter of the bearing 20, and further so that its through hole 18 has a relevant clearance against the axle 20, so that the washer 12 can easily be displaced along the axle 20. Thereafter, a suitably dimensioned counteracting means 14 is arranged on the axle 20 by placing the outer element 22 over axle 20 and the inner element 26 is pushed up on the axle 20 and is pushed into the conical hole of the outer element 22. The inner element 26 is then biased with help of the bushing 38 so that the inner element 26 is prevented from falling out off the outer element 22 in the initial phase of the mounting. Thereafter, the three tightening screws 16 are screwed into the through threaded holes 34 in the outer element 22 and by alternately turn the screws 16 one round at a time, the pressing washer 12 is evenly pushed up along the axle 20 and presses the bearing 40 up along the axle 20. When the tightening screws 16 are screwed into the through holes 34 and are starting to press on the pressing washer 12, i.e. at exertion of a evenly distributed axial force via the tightening means 16, a radially directed locking force arises between the counteracting means 14 and the axle 20. This is caused by the displacement movement between the envelope surfaces 24 and 28. The counteracting means 14 is therefore very by arranged on the axle 20 and thus there is not any risk that the counteracting means 14 slides away along the axle 20 during the bearing mounting procedure. The harmful axial and misalignment loads that arise in the bearing are very small, which provides a mounting that does not damage the bearing nor the components that are connected to the axle.

When the bearing 40 is in place, the tightening screws 16 are screwed out off the counteracting means 14 which afterwards can be disassembled and removed with a suitable tool. Finally, the pressing washer 12 is removed from the axle 20.

In a variant of the described embodiment, which is not shown, the inner element 26 of the counteracting means 14 is instead divided into two cone halves. These are biased with biasing means 38 just like above, which in tins case also prevents the sleeve parts from being locked in an inclined position in relation to each outer.

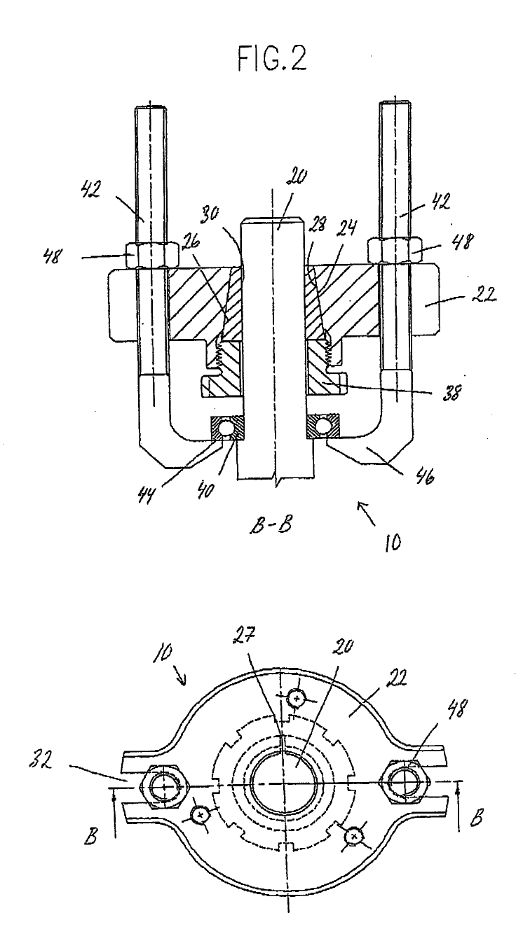

With reference to FIG. 2, dismounting of a bearing 40 from an axle 20 by means of the mounting and dismounting device according to the invention will be described. Dismounting with the device 10 according to the invention is not made exactly in the same way as mounting. The largest differences are that the pressing washer is not at all needed and that the tightening means 16 in the case of dismounting are any sort of withdrawal tool, for instance hook-equipped screws 42. Which type of hook-equipped screws 42 that is needed depends on the position of the bearing 40. In the following a case will be described in which it is free space behind the bearing 40 so that conventional hook-equipped screws can be used, but there are also cases who the bearing is situated in for example a bearing housing and where such hooks can not be used. In such cases, dismounting can be made with for example internal hook tools, which grip the bearing at the race track.

During dismounting, the counteracting means 14 is placed on the axle 20 in a direction opposite that of mounting, i.e. fist the biasing means 38 is placed adjacent the bearing 40, afterwards the inner element 26 of the counteracting means 14 is aged on the axle, and finally the axle is provided with the outer element 22 which is screwed into the biasing means 38. In the recesses 32 of the outer element 22 of the counteracting means 14 the hook-equipped screws 42 are positioned with the hooks 46 positioned against the bottom surface 44 of the bearing 40, and the nuts 48 are screwed onto the upper portions of the screws 42 adjacent the outer element 22 of the counteracting means 14. When the nuts 48 are alternately tightened one round at a time, the forces that arise will lock the counteracting means 14 against the axle 20 and the hooks 46 will displace the bearing 40 out along the axle 20.

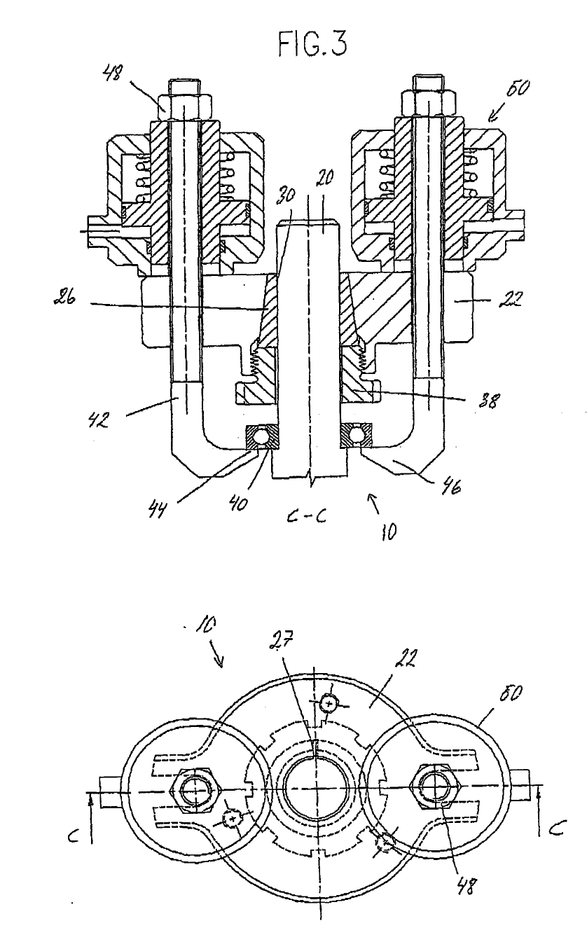

The dismounting of a bearing according to the above does not have to be made manually, instead it is possible to use hydraulics. In an embodiment, which is shown FIG. 3, the tightening means 42 is affected by hydraulic tensioning means 50. Schematically, the tensioning mean 50 works in the same way as the earlier described nuts 48 and can thus lock the counteracting means 14 against the axle 20, simultaneously as the be 40 is pulled out from the axle 20. The advantage of using hydraulics is that it is possible to control the force that is being exerted on the bearing in a reliable way.

It is to be understood that the invention is not limited to the described embodiments, but can be modified within the scope of the attached claims.

### LIST OF REFERENCE NUMERALS

10 mounting and dismounting device

12 pressing means (washer)

14 counteracting means

16 tightening means (screw)

18 hole

20 axle

22 outer element

24 conical inner envelope surface

26 inner element

27 slot

28 conical outer envelope surface

30 hole (inner element)

32 recess/hole (outer element)

34 screw hole (outer element)

36 steel ball

38 biasing means (bushing)

40 bearing

42 tightening means (hook-equipped screw)

44 bottom side (bearing)

46 hook

48 nut

50 hydraulic tensioning means

1. Mounting and dismounting device (10) or annular element (40) being mountable on an axle (20), which device (10) comprises pressing means (12), counteracting means (14) and tightening means (16, 42), where the tightening means (16, 42) is connectable to the counteracting means (14) for transfer of axial force to the machine element (40),
characterized in,
that the counteracting means (14) comprises two parts can be provided in an optional position on the axle (20) and is provided to exert a radial force lock the counteracting means (14) against the axle (20) in the optional position, at exertion of axial force via the tightening means (16, 42), and
that the counteracting means (14) comprises an outer element (22) with a conical inner envelope surface (24) and an inner element (26) with a corresponding conical outer envelope surface (28) and a cylindrical inner surface.

2. Device a according to claim 1,
characterized in,
that the inner element (26) of the counteracting means (14) is slotted.

3. Device according to claim 1,
characterized in,
that the inner element (26) of the counteracting means (14) is in two parts.

4. Device according to claim 1,
characterized in,
that the counteracting means (14) comprises treaded, through holes (34) for tightable screws (16).

5. Device according to claim 1,
characterized in,
that to counteracting means (14) comprises through holes (32) for tightable hook-equipped screws (42).

6. Device according to claim 1,
characterized in,
that tightening means (42) is effected by hydraulic means (50).

7. Device according to claim 1,
characterized in,
that the number of tightening means (16, 42) is at least two.

8. Device according to claim 1,
characterized in,
that the tightening means is screws (16).

9. Device according to claim 1,
characterized in,
that the tightening means is hook-equipped screws (42).
